(19) United States
(12) Patent Application Publication
(10) Pub. No.: US 2008/0237949 A1
(43) Pub. Date: Oct. 2, 2008

(54) Vibration damping device

(75) Inventor: Koichi Hasegawa, Kasugai-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., Komaki-shi (JP)

(21) Appl. No.: 12/076,603

(22) Filed: Mar. 20, 2008

(30) Foreign Application Priority Data
Mar. 28, 2007 (JP) 2007-084654

(51) Int. Cl. F16M 13/00

(52) U.S. Cl. 267/140

(57) ABSTRACT

A vibration damping device having a mass member elastically supported via a spring member on a vibrating member to be damped thereby constituting a secondary vibration system for the vibrating member. The spring member comprises a plurality of rubber elastic bodies being positioned in a parallel arrangement along a vibration input direction, and the mass member is elastically supported at multiple spring support points formed by the plurality of rubber elastic bodies such that a center of gravity of the mass member is positioned between the multiple spring support points and away from a combined elastic center axis of multiple spring support points so as to establish multiple natural frequencies in the vibration input direction, and such that the multiple natural frequencies are tuned to multiple vibration frequencies to be damped in the vibrating member.

### INCORPORATED BY REFERENCE

The disclosure of Japanese Patent Application No. 2007-084654 filed on Mar. 28, 2007, including the specification, drawings and abstract is incorporated herein by reference in its entirety.

### BACKGROUND OF THE INVENTION

1. Field of the Invention

The present invention pertains to a vibration damping device which constitutes a secondary vibration system for vibrating components to be damped, and which is used to suppress vibration of the vibrating components constituting the primary vibration system. The present invention in particular to a vibration damping device of novel construction which affords excellent vibration damping action across multiple frequency ranges.

2. Description of the Related Art

Dynamic dampers (dynamic shock absorbers) which are composed of a mass spring system and are designed to be installed on a vibrating component of primary vibration system so as to constitute a secondary vibration system are known in the art as one kind of vibration damping device used for the purpose of reducing vibration of vibrating components, such as the body of an automobile, vibration of which can be a problem. Such devices have been disclosed, for example, in JP-A-9-264380 and JP-U-1-150245.

Typically, in these dynamic dampers, the intended vibration damping action is effectively achieved through proper tuning of the natural frequency of the secondary vibration system to the frequency of the vibration being damped. Therefore, conventional practice was to position the center of gravity of the mass member constituting the mass, with a high degree of accuracy on the elastic center axis of the spring member constituting the spring in order to consistently produce a single natural frequency in the secondary vibration system, as taught in the aforesaid JP-A-9-264380 and JP-U-1-150245, for example.

However, in a dynamic damper of this kind, effective vibration damping action is produced only at the specific natural frequency to which the secondary vibration system has been tuned. Therefore, in the cases where vibration damping action across multiple frequency ranges is required, it was necessary to independently install multiple dynamic dampers tuned to each of the frequency ranges. However, installing multiple dynamic dampers is undesirable due to the increased weight and lower space efficiency. There was also a risk of the mass members colliding with one another due to deflection of the members where multiple dynamic dampers are installed at locations close together.

There has accordingly been proposed inter alia in JP-A-10-274285 a vibration damping device for installation on a rotating shaft such as the propeller shaft of an automobile, and in which a rubber elastic body which serves as a spring member supporting the mass member is given varying thickness dimension so as to have different natural frequency in the direction of arrangement of the thick part of the rubber elastic body versus the direction of arrangement of the thin part.

A vibration damping device like that taught in the aforesaid JP-A-10-274285 has a single natural frequency in each of two directions, namely, the direction of arrangement of the thick part of the rubber elastic body versus the direction of arrangement of the thin part. Viewed in a specific direction of vibration input, there is only a single natural frequency. Consequently, it was difficult to achieve effective vibration damping action where vibration of multiple frequency ranges is input in a given direction.

US-A-2006157903 discloses a vibration damping device for installation on a rotating shaft in the same manner as the aforesaid JP-A-10-274285. The vibration damping device has a high spring part and a low spring part which are formed by varying in the circumferential direction the free length of a rubber elastic body which serves as the spring member supporting the mass member, with these spring parts having different natural frequencies. However, a vibration damping device like that taught in the aforesaid US-A-2006157903 has the problem that, since the two spring parts are integrally formed, respective distinct resonance point peaks of the spring parts are not obtained. Furthermore, as in the aforesaid JP-A-10-274285, the vibration damping device has a specific shape, i.e. a cylindrical mass member that fits externally about and is positioned spaced apart from the rotating shaft, making it difficult for the device to be implemented in a vibrating member that does not have a rod shape, such as the body of an automobile for example.

Thus, none of the vibration damping devices mentioned above sufficiently afford damping action effective against vibration of multiple frequency ranges input in the same direction.

### SUMMARY OF THE INVENTION

It is an object of the present invention to provide a vibration damping device of novel structure capable, based on a simple mechanical configuration, of exhibiting excellent damping action of vibration of multiple frequency ranges input in the same direction.

The embodiments of the present invention intended to address the issues discussed above will be described hereinbelow. The constituent elements employed in the modes described below may be employed in any possible combination.

A first mode of the invention provides a vibration damping device comprising: a mass member elastically supported via a spring member on a vibrating member to be damped thereby constituting a secondary vibration system for the vibrating member, wherein the spring member comprises a plurality of rubber elastic bodies being positioned in a parallel arrangement along a vibration input direction, and the mass member is elastically supported at multiple spring support points formed by the plurality of rubber elastic bodies such that a center of gravity of the mass member is positioned between the multiple spring support points and away from a combined elastic center axis of multiple spring support points so as to establish multiple natural frequencies in the vibration input direction, and such that the multiple natural frequencies are tuned to multiple vibration frequencies to be damped in the vibrating member.

In the vibration damping device of construction according to the present mode, the multiple spring support points constitute a multiple degree-of-freedom system, thereby affording a vibration damping device endowed with multiple natural frequencies. In the present mode in particular, since the center of gravity of the mass member is positioned away from the combined elastic center axis of multiple spring support points, the rubber elastic bodies which constitute the spring support points can be utilized as substantially decoupled, independent springs. Consequently, a vibration damping device having multiple natural frequencies can be realized on the basis of a simple mechanical configuration, installation space can be utilized more efficiently, and since a single mass member is sufficient, member weight can be reduced as well.

In the vibration damping device of structure according to the present mode, since the multiple support points are constituted by a plurality of rubber elastic bodies, each of the rubber elastic bodies can be made to produce a distinct peak of natural frequency to afford better vibration damping effect. Furthermore, since the plurality of rubber elastic bodies are positioned in a parallel arrangement along the vibration input direction and multiple natural frequencies are established in the same input direction, effective vibration damping of vibration of multiple frequency ranges in the same input direction can be achieved.

A second mode of the invention provides a vibration damping device according to the first mode, wherein the mass member having an elongated shape is positioned spaced apart to an upper side of the vibrating member in a vertical direction; two lengthwise side sections of the mass member are respectively linked to and supported on the vibrating member by the rubber elastic bodies; and an elastic center axis extending in the vertical direction through the rubber elastic bodies supporting the two lengthwise side sections of the mass member is oriented so as to intersect, in a width direction of the mass member, a center axis which extends in a lengthwise direction of the mass member through the center of gravity of the mass member.

The vibration damping device of construction according to the present mode can provide a vibration damping device that has two vibration modes and natural frequencies owing to the two spring support points which support the two side sections of the elongated mass member. Specifically, in the event that vibration having a frequency close to the natural frequency on the low-frequency end of the two natural frequencies is input, motion similar to pitching centered at a location away from the mass member will be produced in the mass member. On the other hand, in the event that vibration having frequency close to natural frequency on the high-frequency end is input, motion similar to pitching centered within the mass member will be produced. Different vibration modes will be respectively exhibited thereby, and excellent vibration damping action can be achieved through each of these vibration modes.

In the width direction of the mass member, the elastic center axis of the rubber elastic body intersects a center axis which extends in the lengthwise direction of the mass member through the center of gravity of the mass member, whereby moment about the center axis extending in the lengthwise direction occurring in the mass member due to input of vibration can be inhibited, allowing the mass member to undergo displacement in consistent manner. Furthermore, since the rubber elastic bodies are positioned at the sides of the mass member, it is possible to avoid the mass member striking the vibrating member, even if the mass member undergoes excessive displacement towards the vibrating member side.

In the present mode, one or a plurality of rubber elastic bodies may support each of the two lengthwise side portions of the mass member. For example, where an end of the mass member is supported by a plurality of rubber elastic bodies, if any of these rubber elastic bodies become damaged, the mass member and the vibrating member can be maintained in the linked state by the remaining rubber elastic bodies, thus providing a fail-safe structure that prevents the mass member from detaching from the vibrating member.

A third mode of the present invention provides a vibration damping device according to the second mode, wherein the two lengthwise side sections of the elongated mass member are linked to and supported on the vibrating member by two of the rubber elastic bodies having mutually different spring constant.

In the vibration damping device of structure according to the present mode, since the mass member is supported by two rubber elastic bodies, a vibration damping device according to the present invention can be realized through a simple configuration. Moreover, since there are two rubber elastic bodies, it will be easy to calculate the location of the combined elastic center axis of the spring support points formed by these rubber elastic bodies, making it easier to carry out tuning so as to give the desired vibration damping characteristics.

A fourth mode of the present invention provides a vibration damping device according to the first mode, wherein the mass member is elastically supported at three of the spring support points, with the center of gravity of the mass member situated a location overlapping in vibration input direction a plane bounded by these three spring support points.

In the vibration damping device of structure according to the present mode, when vibration is input, the spring support point having natural frequency closest to the frequency of the input vibration will be induced to vibrate appreciably, producing motion similar to pitching in the mass member. Thus, each of the rubber elastic bodies can be decoupled with respect to the other rubber elastic bodies, affording a vibration damping device that has three distinct natural frequencies.

A fifth mode of the present invention provides a vibration damping device according to any one of the first to fourth modes, wherein of the multiple natural frequencies constituted by the multiple spring support points, the natural frequency on the high-frequency end is 1.2 times or greater the natural frequency on the low-frequency end.

In the vibration damping device of structure according to the present mode, it is possible for example to reduce effects of vibration of a spring support point on the low-frequency end on a spring support point on the high-frequency end, and to advantageously achieve a condition in which the spring support points constituting the natural frequencies are substantially decoupled. It is possible thereby to achieve distinct peaks of natural frequency of each of the spring support points, and to advantageously obtain vibration damping action against multiple frequency ranges.

In the present mode, the natural frequency on the high frequency end will preferably be 1.4 times or greater the natural frequency on the low-frequency end. The inventors have demonstrated through experimentation that doing so affords substantially complete decoupling of the spring support points from one another.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a vertical cross sectional view of a vibration damping device of construction according to a first embodiment of the present invention;

FIG. 2 is a view suitable for explaining spring support points, an elastic center axis and a center of gravity on the vibration damping device;

FIG. 3 is a view suitable for explaining a method of setting a position of a center of gravity of the mass member;

FIGS. 4A and 4B are views suitable for explaining vibration modes of the present vibration damping device;

FIG. 5 is a graph showing change in amplitude of the vibration damping device;

FIG. 6 is a graph showing change in phase of the vibration damping device;

FIG. 7 is a schematic view showing a vibration damping device of construction according to a second embodiment of the present invention;

FIG. 8 is a graph showing natural frequencies of the vibration damping device; and

FIG. 9 is a schematic view showing a vibration damping device of construction according to another embodiment.

### DETAILED DESCRIPTION OF PREFERRED EMBODIMENTS

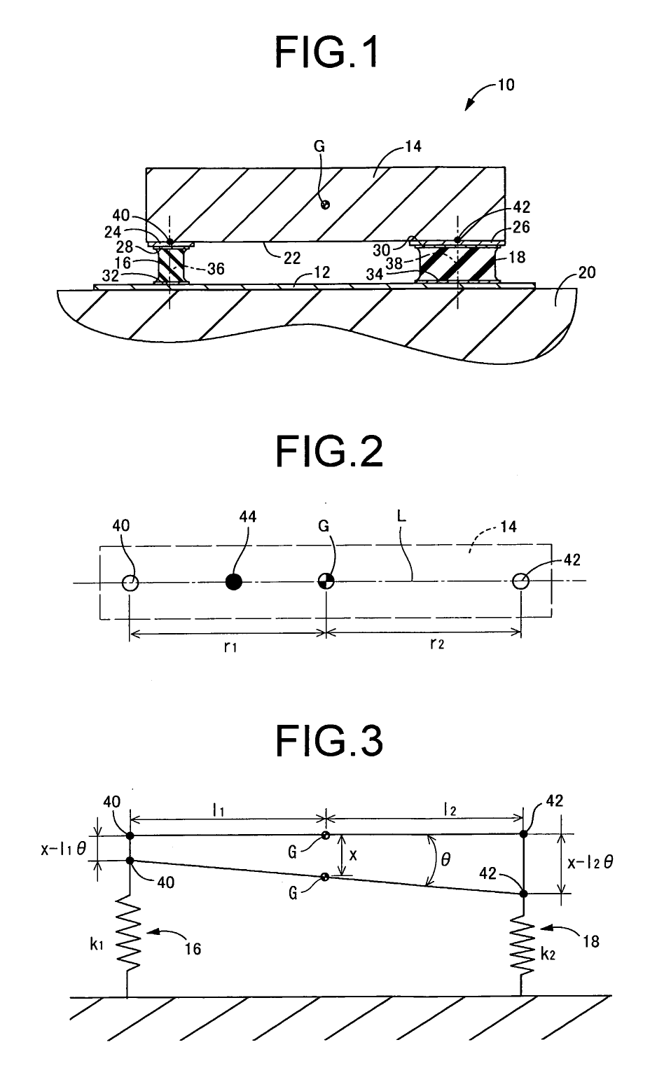

FIG. 1 depicts a dynamic damper 10 as a vibration damping device according to a first embodiment of the present invention. The dynamic damper 10 includes a mass member 14 of metal, which is elastically supported via a pair of rubber leg portions 16, 18 which constitute the rubber elastic bodies on a support plate fitting 12 which constitutes the support member. The support plate fitting 12 is attached to a vibrating member 20 such as the body frame of an automobile, with the mass member 14 elastically supported on the vibrating member 20 by the rubber leg portions 16, 18 so as to constitute a secondary vibration system for the vibrating member 20 which is the primary vibration system. In the following discussion, unless indicated otherwise, vertical direction refers to the vertical direction in FIG. 1. In the present embodiment, this vertical direction represents the plumb vertical direction, which is also the direction of input of vibration.

To describe in greater detail, the mass member 14 is of rectangular block shape having elongated contours. A pair of mounting plate fittings 24, 26 of thin plate shape are attached to either end section of its lower face 22 in the lengthwise direction (the sideways direction in FIG. 1).

The rubber leg portions 16, 18, which constitute a spring member, are attached to the mounting plate fittings 24, 26 of the mass member 14. These rubber leg portions 16, 18 are formed by rubber elastic bodies of columnar shape having unchanging, generally rectangular cross section, and take the form of vulcanization-molded articles with upper plate fittings 28, 30 vulcanization bonded to their upper end face and lower plate fittings 32, 34 vulcanization bonded to their lower end face. The upper plate fittings 28, 30 of the rubber leg portions 16, 18 are affixed at their upper face to the mounting plate fittings 24, 26 which have been disposed on the mass member 14, while the lower faces of the lower plate fittings 32, 34 are affixed juxtaposed against the support plate fitting 12. The mass member 14 is thereby positioned above the support plate fitting 12 and spaced a prescribed distance away from it. The rubber leg portions 16, 18 are attached so as to extend in the perpendicular direction to the lower face 22, in other words, parallel to each other in the vibration input direction, from the two lengthwise end portions of the lower face 22 of the mass member 14 which faces the support plate fitting 12. Thus, the mass member 14 is elastically supported on the support plate fitting 12 by the rubber leg portions 16, 18.

Here, the intersection points of the center axes 36, 38 of the rubber leg portions 16, 18 with the lower face 22 of the mass member 14 constitute spring support points 40, 42. The mass member 14 is elastically supported on this pair of spring support points 40, 42. The rubber leg portions 16, 18 have mutually different cross sectional dimensions, giving them different dynamic spring constants. In the present embodiment, the cross sectional dimension of the rubber leg portion 16 is smaller than the cross sectional dimension of the rubber leg portion 18. Thus, the dynamic spring constant of the rubber leg portion 16 will lower than the dynamic spring constant of the rubber leg portion 18. As depicted in model form in FIG. 2, the combined elastic center axis 44 of the spring support points 40, 42 extends in the plumb vertical direction of the rubber leg portions 16, 18, at a location somewhat closer to the spring support point 40 from the center point between the spring support points 40, 42.

The dynamic spring constants of the rubber leg portions 16, 18 are established such that, of the two natural frequencies exhibited by the dynamic damper 10, the natural frequency on the high-frequency end is a 1.2 times or greater, preferably 1.4 times or greater, the natural frequency on the low-frequency end.

Additionally, the center of gravity: G of the mass member 14 is situated between the spring support points 40, 42. The combined elastic center axis 44 of the spring support points 40, 42 is also situated between the spring support points 40, 42, as well as being situated so as to intersect in the width direction of the mass member 14 (the vertical direction in FIG. 2) a center axis: L which extends in the lengthwise direction of the mass member 14 (the sideways direction in FIG. 2) through the center of gravity: G of the mass member 14. In the present embodiment in particular, through this arrangement the center of gravity: G, the two spring support points 40, 42, and their combined elastic center axis 44 will be positioned so as to overlap the center axis: L of the mass member 14 in the width direction. By situating the elastic center axis 44 closer towards the spring support point 40 as described above, the center of gravity: G of the mass member 14 and the elastic center axis 44 will be positioned at mutually separate locations, rather than overlapping.

Here, the location of the center of gravity: G of the mass member 14 can be determined in the following manner for example, for the purpose of decoupling the rubber leg portions 16, 18. First, assume a case of vertical movement and of rotational movement of the mass member 14 like that depicted in FIG. 3. In FIG. 3, dynamic spring constants of the rubber leg portions 16, 18 are denoted respectively as k1 and k2. The distances between the center of gravity: G of the mass member 14 and the spring support points 40, 42 are denoted as l1 and l2. The mass of the mass member 14 is denoted as M. The moment of inertia about the center of gravity: G is denoted as J. Displacement of the center of gravity of the mass member 14 in the plumb vertical direction is denoted as x. The rotation angle of the mass member 14 about the center of gravity is denoted as θ. In the condition of FIG. 3, the following Equation 1 will be true for vertical motion of the center of gravity: G of the mass member 14, while the following Equation 2 will be true for rotational motion of the center of gravity: G of the mass member 14.

M\ddot{x}=−k₁(x−l₁θ)−k₂(x+l₂θ) [Equation 1]

J\ddot{θ}=k₁(x−l₁θ)l₁−k₂(x+l₂θ)l₂ [Equation 2]

From the aforementioned Equation 1, the following Equation 3 is true. From the aforementioned Equation 2, the following Equation 4 is true. In Equation 3 and Equation 4, kₓ=k₁+k₂ represents the spring constant, kθ=k₁l₁²+k₂l₂² represents the rotational spring constant, and the third term kₓθ=k₁l₁²−k₂l₂² represents a coupling term coefficient.

M\ddot{x}+kₓx−k_{xθ}θ=0 [Equation 3]

J\ddot{θ}+k₇₄θ−k_{xθ}x=0 [Equation 4]

Here, where k₁l₁^{2=k}₂l₂² the coupling term will be zero, and vertical movement and rotational movement of the mass member 14 will take place as independent movements unrelated to one another. Consequently, for the purpose of decoupling the rubber leg portions 16, 18 it will be effective to set to the location of the center of gravity: G of the mass member 14 to a location that fulfills the expression k₁l₁^{2=k}₂l₂². In this case, the natural frequency of vertical movement will be given by the following Equation 5, and the natural frequency of rotational movement by the following Equation 6. These natural frequencies will be tuned to the frequencies of vibration to be damped in the vibrating member 20.

$$\begin{matrix}{ω}_{x} = \sqrt{\frac{{k}_{x}}{M}} & [ Equation 5 ] \\ {ω}_{θ} = \sqrt{\frac{{k}_{θ}}{J}} & [ Equation 6 ]\end{matrix}$$

The equivalent mass of each spring support point 40, 42, denoted as M₁ in the case of equivalent mass at the spring support point 40 for example, can be derived from the following Equation 7. In Equation 7, Ax denotes a correction coefficient; r1 denotes the distance from the center of gravity: G to the spring support point 40 as shown in FIG. 2; and r₁′ denotes the distance from the center of gravity: G to the spring support point 42.

$${M}_{1} = {A}_{x} \times M \times \frac{{r}_{2}}{{r}_{1} + {r}_{2}} \qquad [ Equation 7 ]$$

The dynamic damper 10 having a structure like that described above is mounted onto the vibrating member 20 by bolting or welding the support plate fitting 12. The two lengthwise end sections of the mass member 14 are thereby elastically coupled with and supported on the vibrating member 20 constituting the primary vibration system by the rubber leg portions 16, 18, constituting a secondary vibration system in which the mass member 14 is the mass and the rubber leg portions 16, 18 are the springs, and which can function in its entirety as a dynamic damper.

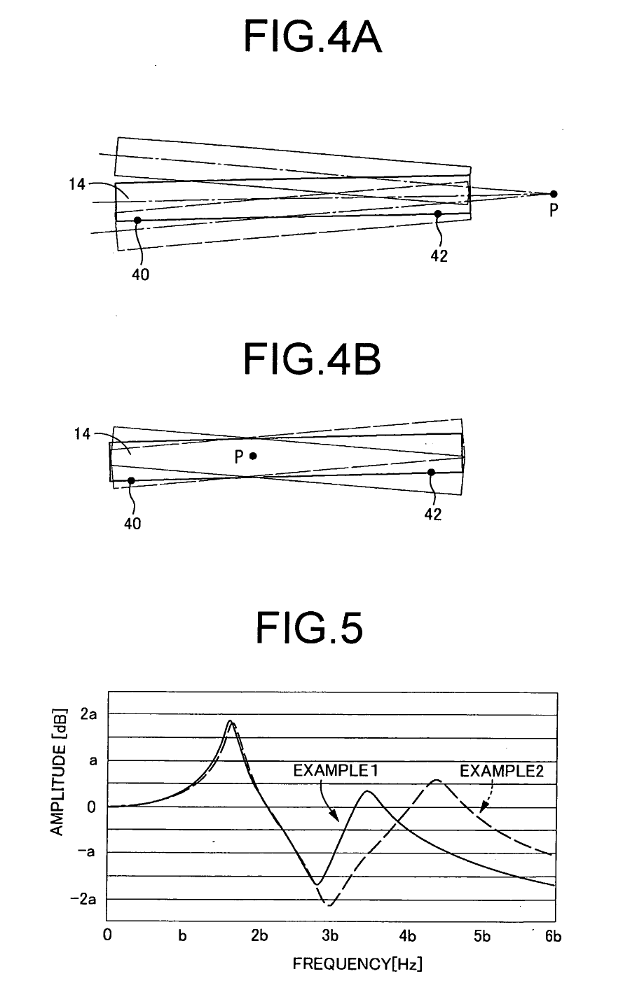

In the dynamic damper 10 of the present embodiment in particular, the center of gravity: G of the mass member 14 is established at a location away from the elastic center axis 44 of the spring support points 40, 42. By so doing, when vibration is input motion resembling pitching will be produced in the mass member 14 as depicted in FIGS. 4A and 4B. Specifically, where low-frequency vibration is input, the mass member 14 will experience oscillation centered on a point P away from the mass member 14 towards the rubber leg portion 18 end, as depicted in FIG. 4A. Thus, where low-frequency vibration has been input the vibration damping action will be produced by the rubber leg portion 16, which has a low dynamic spring constant setting. On the other hand, where high-frequency vibration is input the mass member 14 will experience oscillation centered on a point P within the mass member 14 as depicted in FIG. 4B. Thus, when where high-frequency vibration is input the vibration damping action will be produced by the rubber leg portion 18, which has a high dynamic spring constant setting. By setting the center of gravity: G of the mass member 14 to a location away from the elastic center axis 44 of the spring support points 40, 42 in this way, it is possible to decouple the rubber leg portions 16, 18 which constitute the spring support points 40, 42 and provide the dynamic damper 10 of the present embodiment with two mutually independent degree-of-freedom systems. It will be possible thereby for the system to have two vibration modes and natural frequencies with respect to vibration input in the same direction.

In the dynamic damper 10 of the present embodiment in particular, the center axes 36, 38 of the rubber leg portions 16, 18 are positioned parallel to each other and extending in the same direction. Thus, either of the rubber leg portions 16, 18 can produce vibration damping action with respect to input vibration in the same direction (in the present embodiment, the vertical direction), making it possible to achieve effective vibration damping action against vibration of multiple frequency ranges input in the same direction. In this way the dynamic damper 10 of the present embodiment can, through a simple mechanical configuration, be endowed with excellent vibration damping action against vibration of multiple frequency ranges input in the same direction, thus affording excellent space efficiency as well as making it possible to reduce the weight of member, since a single mass member is sufficient.

Furthermore, in the dynamic damper 10 of the present embodiment, the elastic center axis 44 is set to intersect the center axis: L which passes through the center of gravity: G of the mass member 14. The mass member 14 can thereby be induced to undergo displacement in a consistent manner in the direction of vibration input. Additionally, the dynamic damper 10 of the present embodiment is mounted onto the vibrating member 20 by the support plate fitting 12 which is of plate shape. It can thereby be mounted regardless of the particular shape of the vibrating member 20 and is suitable for use with vibrating members having a wide range of shapes. Moreover, since the rubber leg portions 16, 18 are positioned at the two lengthwise end portions of the mass member 14 in the dynamic damper 10 of the present embodiment, it is possible to prevent the mass member 14 from striking against the support plate fitting 12, even if the mass member 14 should experience excessive displacement.

Furthermore, in the dynamic damper 10 of the present embodiment, of the two natural frequencies, the natural frequency on the high-frequency end is 1.2 times or greater, preferably 1.4 times or greater, the natural frequency on the low-frequency end. It is possible thereby to reduce or eliminate interaction between the two natural frequencies, making it possible to obtain a distinct peak for each respective natural frequency.

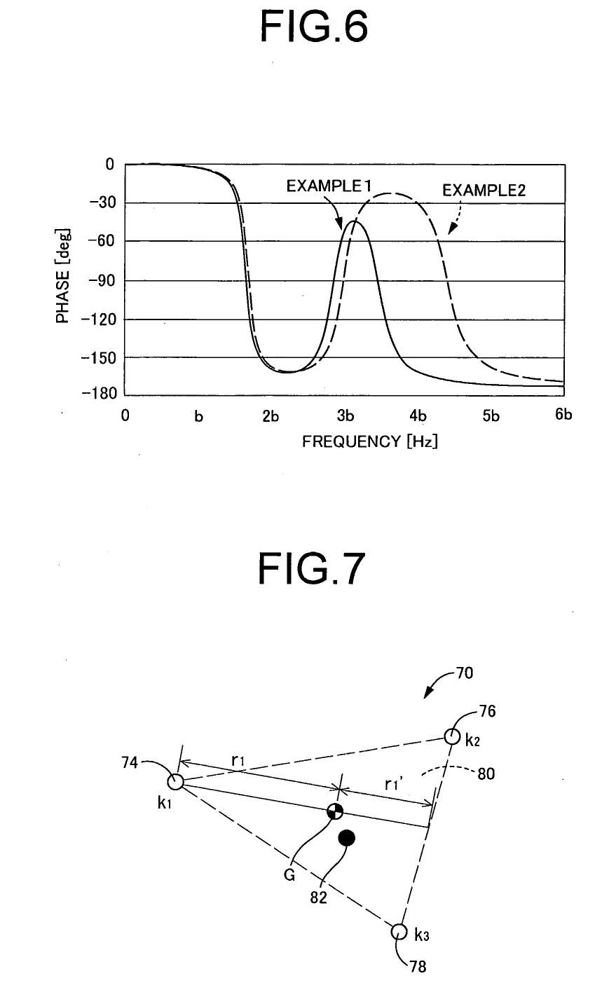

FIG. 5 shows measured change in amplitude, and FIG. 6 shows change in phase at the center of gravity location of the mass member 14, observed with the dynamic damper 10 having structure according to the present invention when input vibration frequency was changed gradually over a prescribed range. FIGS. 5 and 6 show measurements for two dynamic dampers of structure according to the present invention, whose rubber leg portions 18 have different dynamic spring constants. In Example 1 in FIGS. 5 and 6, the settings were: mass of the mass member 14=1 kg; dynamic spring constant of the rubber leg portion 16=100 N/mm; and dynamic spring constant of the rubber leg portion 18=300 N/mm. In Example 2 on the other hand, the settings were: mass of the mass member 14=1 kg; dynamic spring constant of the rubber leg portion 16=100 N/mm; and dynamic spring constant of the rubber leg portion 18=500 N/mm.

As will be apparent from FIG. 5, in Example 1, it was found that a natural frequency on the low-frequency end is produced at about 2b (Hz), while a natural frequency on the high-frequency end is produced at about 3.5b (Hz). In Example 2, it was found that a natural frequency on the low-frequency end is produced at about 2b (Hz), while a natural frequency on the high-frequency end is produced at about 4.5b (Hz). In this way, dynamic dampers 10 having structure according to the present invention are demonstrated to have two distinct natural frequencies. In Example 1 and Example 2, the dynamic spring constant of the rubber leg portion 18 differs while the dynamic spring constant of the rubber leg portion 16 is the same. As will be apparent from FIG. 5, in Examples 1 and 2 there is no appreciable change in natural frequency on the low-frequency end; only the natural frequency on the high-frequency end changes. This demonstrates that the rubber leg portions 16, 18 act in a decoupled fashion, with the rubber leg portions 16, 18 producing generally independent vibration damping action. In each of the examples, the natural frequency on the high-frequency end is 1.4 times or greater the natural frequency on the low-frequency end. It was demonstrated that is possible thereby to eliminate interaction between the natural frequencies, and achieve excellent vibration damping action based on distinct respective peaks.

As will be apparent from FIG. 6, in Example 1, 90° phase delay was found to be produced at about 2b (Hz) and about 3.5b (Hz). In Example 2, 90° phase delay was found to be produced at about 2b (Hz) and about 4.5b (Hz). This also serves to demonstrate that dynamic dampers 10 having structure according to the present invention have two distinct natural frequencies. It was also demonstrated that, since both Examples 1 and 2 employed identical rubber leg portions 16 of small spring constant, phase delay on the low-frequency end was produced in a generally similar mode in each example; whereas the rubber leg portions 18 of large spring constant differed between Example 1 and Example 2, phase delay on the high-frequency end was produced in mutually different modes.

TABLE 1

| | 700 N/mm | 900 N/mm | 1800 N/mm |
|---|---|---|---|
| 100 N/mm | 69a | 71a | 65a |
| | 195a | 225a | 379a |
| 130 N/mm | 74a | 75a | 73a |
| | 193a | 227a | 384a |
| 200 N/mm | 100a | 100a | 113a |
| | 202a | 232a | 387a |

In the dynamic damper 10 having structure according to the present invention, three different types of rubber elastic bodies respectively having different dynamic spring constants were prepared for use as the rubber leg portions 16, 18; changes in natural frequency on the low-frequency end and the high-frequency end observed when either the rubber leg portion 16 or 18 was held fixed while the other was varied are shown in Table 1. The vertical direction in Table 1 indicates dynamic spring constant of the rubber leg portion 16 having low dynamic spring constant; three types having respective spring constants of 100 N/mm, 130 N/mm, and 200 N/mm were prepared. The horizontal direction in Table 1 indicates dynamic spring constant of the rubber leg portion 18 having high dynamic spring constant; three types having respective spring constants of 700 N/mm, 900 N/mm, and 1800 N/mm were prepared. Measurements of natural frequency obtained with different combinations of these rubber leg portions 16, 18 are presented with the low-frequency end natural frequencies shown in the upper rows and the high-frequency end natural frequencies shown in the lower rows.

From Table 1 it will be apparent that where, for example, the rubber leg portion 16 having low dynamic spring constant is held constant at 100 N/mm while the rubber leg portion 18 having high dynamic spring constant is changed, the natural frequency on the low-frequency end will remain substantially unchanged at 69a, 71a, and 65a; whereas the natural frequency on the high-frequency end will change between 195a, 225a, and 379a. Also, where, for example, the rubber leg portion 18 having high dynamic spring constant is held constant at 700 N/mm while the rubber leg portion 16 having low dynamic spring constant is changed, the natural frequency on the high-frequency end will remain substantially unchanged at 195a, 193a, and 202a; whereas the natural frequency on the low-frequency end will change between 69a, 74a, and 100a. In this way, where only either one of the rubber leg portions 16, 18 differs the natural frequency produced by the different rubber leg portion 16, 18 will change, whereas the natural frequency produced by the fixed rubber leg portion 16, 18 will remain substantially unchanged. This fact also serves to demonstrate that in a dynamic damper 10 of structure according to the present invention, the two rubber leg portions 16, 18 can be decoupled, and substantially independent vibration damping action can afforded effectively by the respective rubber leg portions 16, 18.

In the dynamic damper 10 of the first embodiment described above, the mass member 14 is supported by two spring support points 40, 42. However, the number of spring support points is not limited to any particular value provided it is two or more, and it would be possible for the mass member to be supported at three or more support points. FIG. 7 depicts by way of example a dynamic damper 70 pertaining to a second embodiment, shown in model form in top view.

The dynamic damper 70 is furnished with a mass member, not shown, which is triangular in shape in top view. A rubber elastic body generally similar to those in the first embodiment is positioned at each apical section constituting an edge of the mass member. The mass member is thereby elastically supported at its apical sections by spring support points 74, 76, 78 constituted by these rubber elastic bodies.

The dynamic spring constants of the spring support points 74, 76, 78 will be such that the dynamic spring constant of any one support point differs from the combination dynamic spring constant of the other support points. Specifically, where the dynamic spring constants of the spring support points 74, 76, 78 are denoted as k₁, k₂, k₃, then in preferred practice k₁≠k₂+k₃, k₂≠k₁+k₃, and k₃≠k₁+k₂.

The center of gravity: G of the mass member overlaps in the direction of vibration input (the direction perpendicular to the plane of the paper in FIG. 7) a triangular plane 80 which is bounded by these spring support points 74, 76, 78, and is situated away from the combined elastic center axis 82 of the spring support points 74, 76, 78.

In the present embodiment, as in the first embodiment discussed previously, equivalent mass at the spring support points 74, 76, 78 can derived from the following Equation 8, where equivalent mass at the spring support point 74 is denoted as M₁ for example. In Equation 8, M denotes the mass of the mass member, Aₓ denotes a correction coefficient; r₁ denotes the distance from the center of gravity: G to the spring support point 74; and r₁′ denotes the distance from the center of gravity: G to a straight line connecting the spring support points 76 and 78.

$${M}_{1} = {A}_{x} \times M \times \frac{{r}_{1}^{′}}{{r}_{1} + {r}_{1}^{′}} \qquad [ Equation 8 ]$$

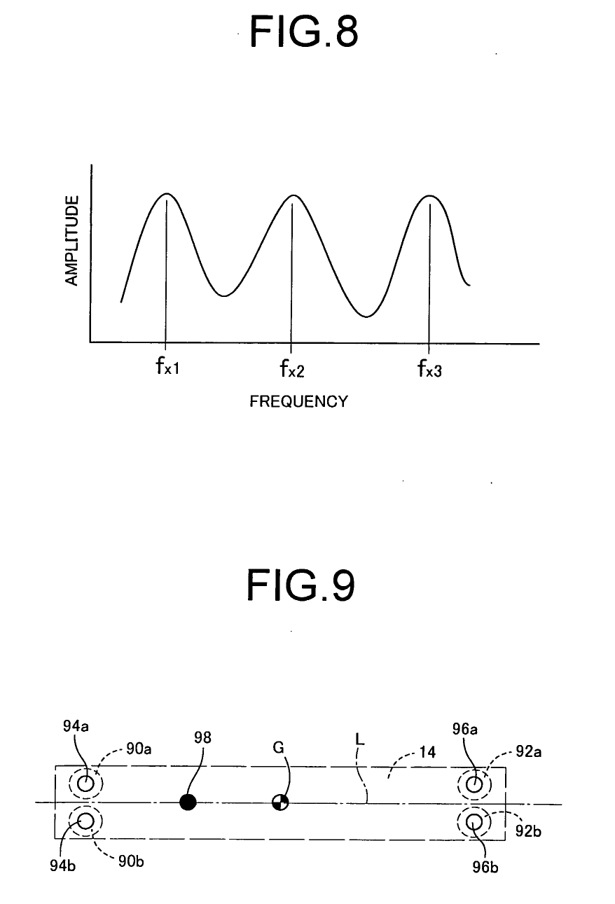

In the dynamic damper 70 having such a structure, the spring support points 74, 76,78 can be decoupled, and three distinct natural frequencies fₓ₁, fₓ₂, fₓ₃ can be provided as depicted in model form in FIG. 8. Here, in preferred practice the natural frequencies fₓ₁, fₓ₂, fₓ₃ will be such that the natural frequency on the high-frequency end is 1.2 times or greater the natural frequency on the low-frequency end (e.g. in FIG. 8, fₓ₂>fₓ₁×1.2, fₓ₃>fₓ₂×1.2), and preferably 1.4 times or greater. As in the first embodiment, it will be possible thereby to reduce or eliminate interaction between the natural frequencies fₓ₁, fₓ₂, fₓ₃, and achieve excellent vibration damping action based on a distinct respective peak at each natural frequency.

While the present invention has been described in detail herein through certain preferred embodiments, these are merely exemplary and the invention should not be construed as limited to the specific disclosure of the embodiments, and various alterations, modifications, and improvements thereto will be apparent to the practitioner of the art, which embodiments shall naturally be considered to fall within the scope of the invention insofar as they do not depart from the spirit thereof.

For example, in each of the embodiments described above, a single rubber elastic body is positioned at the ends of the mass member. However, the ends of the mass member could instead be elastically supported by a plurality of rubber elastic bodies as depicted in model form in FIG. 9. Specifically, in the present embodiment, at the two lengthwise end portions of a mass member 14 of elongated shape, pairs of rubber leg portions 90a, 90b and 92a, 92b could be respectively disposed as rubber elastic bodies arranged in the width direction of the mass member 14 (the vertical direction in FIG. 9) so that the two ends of the mass member 14 are respectively linked to and elastically supported on the vibrating member by these pairs of rubber leg portions 90a, 90b and 92a, 92b. The two lengthwise end portions of the mass member 14 will thereby be respectively elastically supported at spring support points 94a, 94b, 96a, 96b formed by the rubber leg portions 90a, 90b, 92a, 92b. Here, the rubber leg portions 90a, 90b, 92a, 92b are respectively positioned so as to extend in the plumb vertical direction (the direction perpendicular to the plane of the paper in FIG. 9), in other words, in the direction of vibration input, and the combined elastic center axis 98 of the spring support points 94a, 94b, 96a, 96b formed by these rubber leg portions 90a, 90b, 92a, 92b is formed so as to extend in the direction of vibration input. As in the first embodiment, the elastic center axis 98 intersects in the width direction of the mass member 14 a center axis: L which passes in the lengthwise direction of the mass member 14 through the center of gravity: G of the mass member 14. That is, the mass member 14 is supported at a plurality of sections, and each of said sections are supported by a plurality of rubber leg portions 90a, 90b, 92a, 92b.

It is possible in this way to support one end of the mass member with multiple rubber elastic bodies. With this arrangement, if any of these rubber elastic bodies become damaged, the mass member can be maintained in the linked state to the vibrating member by the remaining rubber elastic bodies, thus providing a fail-safe structure that prevents the mass member from detaching from the vibrating member. It would of course be possible, for example, to support the ends of the mass member with a greater number of rubber elastic bodies; or to support either end with a single rubber elastic body while supporting the other end with multiple rubber elastic bodies.

In the embodiments described previously, by making the combined elastic center axis of the spring support points eccentric, the center of gravity of the mass member and the elastic center axis of the spring support points are positioned at locations apart from one another. However, in place of or in combination with this method, the location of the center of gravity of the mass member could be made eccentric by changing the shape of the mass member etc., to situate the elastic center axis of the spring support point and the location of the center of gravity of the mass member apart from one another.

The specific shape of the mass member and the rubber elastic bodies is not limited in any particular way, and any or various shapes may be employed as appropriate.

The vibration damping device pertaining to the present invention should be understood to be adaptable to implementation in a wide range of components in which vibration poses a problem, such as an automotive body, sub-frame, engine block, seats, steering components, instrument panel, doors, mirrors, etc. or in various non-automotive devices.

What is claimed is:

1. A vibration damping device comprising:
a mass member to be elastically supported via a spring member on a vibrating member to be damped thereby constituting a secondary vibration system for the vibrating member,
wherein the spring member comprises a plurality of rubber elastic bodies being positioned in a parallel arrangement along a vibration input direction, and
the mass member is elastically supported at multiple spring support points formed by the plurality of rubber elastic bodies such that a center of gravity of the mass member is positioned between the multiple spring support points and away from a combined elastic center axis of multiple spring support points so as to establish multiple natural frequencies in the vibration input direction, and such that the multiple natural frequencies are tuned to multiple vibration frequencies to be damped in the vibrating member.

2. The vibration damping device according to claim 1, wherein the mass member having an elongated shape is positioned spaced apart to an upper side of the vibrating member in a vertical direction; two lengthwise side sections of the mass member are respectively linked to and supported on the vibrating member by the rubber elastic bodies; and the combined elastic center axis extending in the vertical direction through the rubber elastic bodies supporting the two lengthwise side sections of the mass member is oriented so as to intersect, in a width direction of the mass member, a center axis which extends in a lengthwise direction of the mass member through the center of gravity of the mass member.

3. The vibration damping device according to claim 1, wherein the two lengthwise side sections of the elongated mass member are linked to and supported on the vibrating member by two of the rubber elastic bodies having mutually different spring constant.

4. The vibration damping device according to claim 1, wherein the mass member is elastically supported at three of the spring support points, with the center of gravity of the mass member situated at a location overlapping in the vibration input direction a plane bounded by these three spring support points.

5. The vibration damping device according to claim 1, wherein of the multiple natural frequencies constituted by the multiple spring support points, the natural frequency on a high-frequency end is 1.2 times or greater the natural frequency on a low-frequency end.

6. The vibration damping device according to claim 1, wherein the mass member is supported at a plurality of sections, and each of said sections are supported by a plurality of rubber elastic bodies.

7. The vibration damping device according to claim 1, wherein the center of gravity of the mass member is established at a location away from the combined elastic center axis of the spring support points so that the rubber elastic bodies are decoupled so as to provide mutually independent degree-of-freedom systems.
